(19) United States
(12) Patent Application Publication
(10) Pub. No.: US 2012/0158515 A1
(43) Pub. Date: Jun. 21, 2012

(54) DYNAMIC ADVERTISEMENT SERVING BASED ON AN AVATAR

(75) Inventor: Malati K., Bangalore (IN)

(73) Assignee: Yahoo! Inc., Sunnyvale, CA (US)

(21) Appl. No.: 12/973,937

(22) Filed: Dec. 21, 2010

(51) Int. Cl. G06Q 30/00

(52) U.S. Cl. 705/14.66

(57) ABSTRACT

Digital advertisements are provided based on avatar changes includes the step of displaying an avatar. The method also includes the step of receiving a change to a characteristic associated with the avatar. Further, the method includes the step of selecting an advertisement based on the characteristic change in relation to metadata associated with the advertisement. Furthermore, the method includes the step of displaying the selected advertisement.

### BACKGROUND

1. Technical Field

Embodiments of the invention relate generally to digital advertisements, and more specifically, to using characteristics of an avatar to select online advertisements.

2. Prior Art

Today, web advertising is a common practice of using the Internet to promote brands and products of various companies. Advertisements can be dynamically placed in a web page on the fly. Targeted advertisements are customized for a particular audience. For example, information about demographics of an audience allow companies to more effectively purchase advertisements to likely customers.

An avatar can be an image representing a personality of a user in a digital application. A user can select a desired avatar from a list of avatars stored in an avatar server. Alternatively, a user can customize certain parts such as appearance, clothing, and behaviors.

Currently, advertisements shown while selecting an avatar have no correlation to the avatar. Consequentially, a user may be inattentive towards the random advertisements.

In the light of the foregoing discussion, there is a need for providing digital advertisements based on characteristics of an avatar.

### SUMMARY

The above-mentioned needs are met with a method, a computer program product, and system for providing a digital advertisement based on characteristics of an avatar.

An example of a method for providing digital advertisements based on avatar changes includes the step of displaying an avatar. The method also includes the step of receiving a change to a characteristic associated with the avatar. Further, the method includes the step of selecting an advertisement based on the characteristic change in relation to metadata associated with the advertisement. Furthermore, the method includes the step of displaying the selected advertisement.

An example of a computer-implemented method for providing digital advertisements based on avatar changes includes the step of receiving an avatar. The computer-implemented method also includes the step of performing an image analysis on the avatar to determine characteristics associated with the avatar. Further, the computer-implemented method includes the step of selecting an advertisement based on at least one characteristic in relation to metadata associated with the advertisement. Furthermore, the computer-implemented method includes the step of displaying the selected advertisement.

An example of a computer program product stored on a non-transitory computer-readable medium that when executed by a processor, performs a method for providing digital advertisements based on avatar changes includes the step of displaying an avatar and receiving a change to a characteristic associated with the avatar. Further, the computer program product includes the step of selecting an advertisement based on the characteristic change in relation to metadata associated with the advertisement to display the selected advertisement. Furthermore, the computer program product includes the step of displaying the selected advertisement.

An example of a system to provide digital advertisements based on avatar changes includes an interface to display an avatar. The interface receives a change to a characteristic associated with the avatar. The system also includes an advertisement selection engine, communicatively coupled to the interface, the advertisement selection engine to select an advertisement based on the characteristic change in relation to metadata associated with the advertisement.

Advantageously, advertisements are effectively tailored towards specific interests of a user.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 is a flow chart illustrating a method for providing digital advertisements based on an avatar according to one embodiment.

FIG. 2 is a flow chart illustrating a method for selecting an online advertisement based on changes to the avatar according to an embodiment.

FIG. 3 is a flow chart illustrating a method for selecting an online advertisements based on an image analysis of the avatar according to an embodiment.

FIG. 4 is a schematic diagram illustrating a graphical user interface (GUI) for exemplary selection of an avatar characteristic in accordance with one embodiment.

FIG. 5 is an exemplary representation of advertisements selected responsive to modifications of avatar characteristics according to one embodiment.

FIG. 6 is a block diagram illustrating a system to provide online advertisements based on an avatar according to one embodiment.

FIG. 7 is a block diagram illustrating a computing device according to one embodiment.

FIG. 8 is a block diagram illustrating an avatar server according to one embodiment.

FIG. 9 is a block diagram illustrating an advertisement selection engine according to one embodiment.

### DETAILED DESCRIPTION

A method, computer program product and a system for providing digital advertisements based on an avatar is disclosed. The following detailed description is intended to provide example implementations to one of ordinary skill in the art, and is not intended to limit the invention to the explicit disclosure, as one or ordinary skill in the art will understand that variations can be substituted that are within the scope of the invention as described.

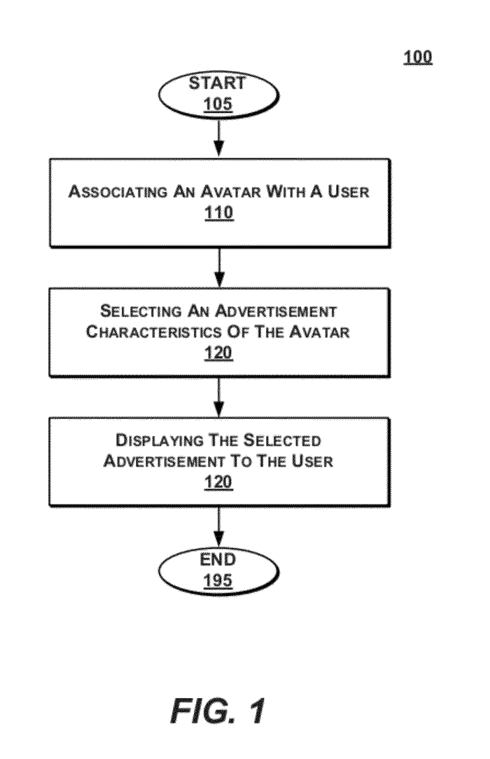

FIG. 1 is a flow chart illustrating a method 100 for providing digital advertisements based on an avatar according to one embodiment. In one embodiment, the method 100 applies to advertisements placed on a web page viewed through a web browser. In another embodiment, the method 100 applies to advertisements placed within a video game played on a console that is web enabled. In yet another embodiment, the method 100 applies to advertisements placed during televisions shows on a web enabled television or set-top box. Although many of the embodiments herein are described within the environment of a web page avatar and advertisement, it will be understood to those of skill in the art that many other environments are possible within the scope of the present invention.

The method starts at step 105. At step 110, an avatar is associated with a user. Generally, an avatar is a graphical digital image, or icon, representing a user. Cartoon characters are one type of popular avatar. The avatar can be associated with a user of a social network, with a profile of a user, or with a player of a video game, among other embodiments. The avatar can exist in various forms. Examples of the various forms include, but are not limited to, a three-dimensional model used in computer games and a two-dimensional picture used on computer forums (e.g., an online discussion site).

The avatar can be selected to physically and non-physically resemble attributes a user. Alternatively, the avatar can resemble fantasy, satirical, or even random attributes. The avatar can also be selected to represent user actions, user interest, beliefs and social status of the user. In some implementations, a library of avatars is preconfigured. In other implementations, characteristics of some avatars can be modified by the user.

Further, an avatar can be set on a background. Examples of the background include, but are not limited to, a resort, an office cubicle, an outdoor scene, a historical landmark, a point of interest, and the like. In one embodiment, the user can select a desired avatar from a list of avatars stored in an avatar server. In another embodiment, the user can design a custom avatar. Many features, or characteristics, of avatars are variable.

The selected avatar is then displayed on the web page (e.g., profile page of Yahoo! Pulse or Facebook). The web page is, in one example, a document consisting of text, images, advertisements and hypertext links. The web page can be implemented in any suitable format, such as a Hypertext markup language (HTML), Hypertext Preprocessor (PHP), Flash, and the like. The web page can be viewed with a web browser, such as Internet Explorer or Mozilla, or a mobile browser. Referring again to the profile page example, the avatar can be displayed in a corner of the web page with a user's name and other personal information. The profile page may also include status updates, an e-mail inbox, RSS (Really Simple Syndication) news feeds, and the like. In some embodiments, the web page also includes advertisements. The advertisements can be placed anywhere, for example, on a side bar, within search results, and scrolling across the bottom. In one embodiment, advertisements of the profile page are selected in connection with changes to the avatar.

The web page including an avatar is associated with the display of a plurality of advertisements on the web page. An advertisement can be text, an image, video or animation related to, for example, a product or a service. The advertisements associated with the avatar, represents one or more products and services. In one embodiment, the advertisement can be a click-through to a new page showing more detailed information. The advertisement can be located in a static position, or dynamically move across a web page.

The avatar present in the web page is characterized by various characteristics including a visual appearance of the avatar. Examples of visual appearance include, but are not limited to, an avatar holding a red bag or the avatar putting on a black hat or a choice of apparel chosen by an avatar. The user can apply one or more characteristics to the avatar. The user can also modify the one or more characteristics of the avatar. The modification can be performed based on the interest of the user.

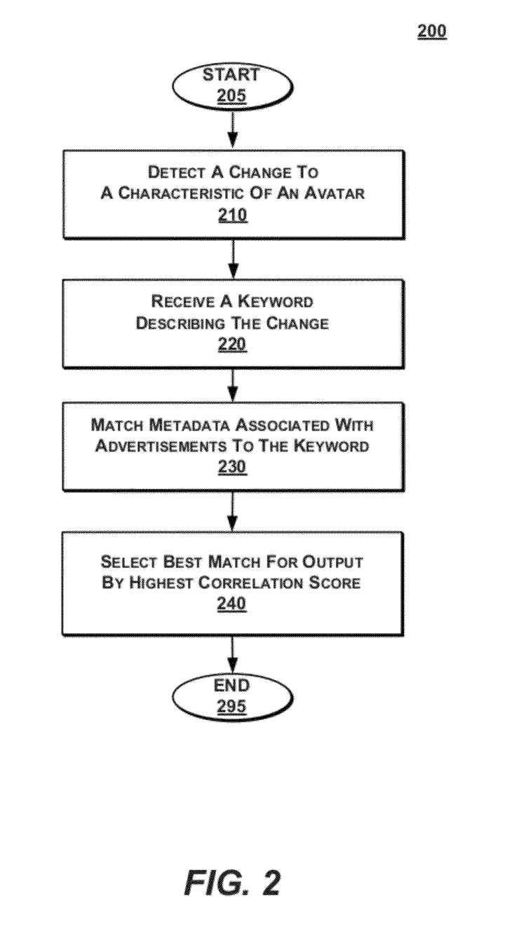

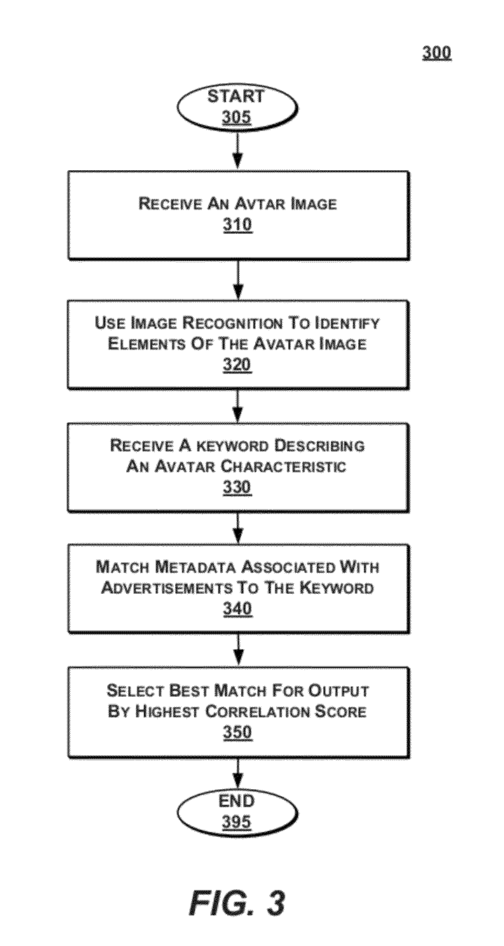

At step 120, an advertisement is selected based on the avatar. Generally, an advertisement is selected from a pool of advertisements based on characteristics of the avatar. In one embodiment, an advertisement is selected based on modifications to characteristics of the avatar (see FIG. 2). Advertisements can be displayed in substantially real-time with the modifications. In another embodiment, an advertisement is selected based on an image analysis of an avatar (see FIG. 3). The image analysis determines physical characteristic of the avatar.

Avatar characteristics can be physical or non-physical. The physical characteristics can include, for example, clothing worn by the avatar or background images that sent an environment for the avatar. The non-physical characteristics can include, for example, behaviors, settings, or demographic information.

In one embodiment, an advertisement is a solicitation by a commercial entity in a digital or analog form. The digital form can be text, an image, a video file, an audio file, stationary or in motion (e.g., scrolling), two-dimensional or three-dimensional. The advertisement can be interactive in that a click or hover over the advertisement causes additional information to be shown, such as a web page of a commercial entity. The subject matter of the advertisement can vary from a commercial or non-commercial product or service, a public service announcement, or any other type of information. In an embodiment, an advertisement is configured for storage on an ad server and for transmission across a digital network. An advertisement can be stored with a pool of advertisements. Each advertisement has associated metadata describing the advertisement. The metadata can relate to content, type of product, product description, part of the country, time of day, tempo, target audience, advertising rate, and the like. The metadata can also include a unique identification tag as string of alphanumeric characters.

Examples of advertisements selected responsive to characteristics include: a listing of spas in the areas responsive to selecting spa clothes for the avatar; brand ads for Oakley and Ray-Ban responsive to selecting eyewear; a list of accessory online shopping sites responsive to selecting jewelry or other accessories; links to sports articles responsive to selecting a sporting background; and a list of local pet clinics responsive to selecting a pet, among many other possibilities.

At step 130, a selected advertisement, which relates to a characteristic, is displayed. In one example, the user can view the selected advertisement on a web page (e.g., an image delineated in the source code). A unique identification tag can be used to distinguish the selected video.

Further, the user can navigate through different web pages by accessing the hypertext links. As the user navigates, different advertisements are selected and displayed. In a second example, the user can view the selected advertisement integrated within a scene of a video game (e.g., on a digital billboard). In another example, the user can view the selected advertisement as an inserted to the video stream of an Internet television.

FIG. 2 is a flow chart illustrating a method 200 for selecting an online advertisements based on changes to an avatar according to an embodiment. The method 200 is another embodiment of step 120, FIG. 2, an additional embodiment discussed below with respect to FIG. 3.

At step 210, a change associated with one or more characteristics of an avatar is detected. The change can be detected by a client executing on a computing device of a user. Also, the change can be detected by pinging a profile to check for avatar changes. Additionally, an avatar server can automatically notify when changes are made.

In one implementation, the characteristic change comprises a change to a visual appearance of the avatar. The user can perform a plurality of changes to a corresponding plurality of characteristics associated with the avatar. Examples of changes include, but are not limited to, changing the color of a bag held by an avatar, switching apparel worn by an avatar, and choosing brands names. Other non-visual changes are possible. Examples of non-visual changes include behavior changes, new settings, and other associated metadata.

At step 220, keywords describing a change are received. The keywords can be chosen by various techniques. For example, categories allowing a user to browse characteristics can be keywords (e.g., summer clothes, hats, Adidas, etc.). Keywords can also describe other characteristics of a user, such as demographics, that are not related to avatar changes.

At step 230, keywords are matched to metadata. The correlation between keywords describing a change and metadata describing an advertisement links an avatar change to a particular advertisement. Consequentially, the one or more advertisements displayed on the web page are based on the change made to the avatar. For example, if the user modifies the avatar by adding a red bag to accessories of the avatar, then advertisements related to various bags are displayed on the web page.

In one embodiment, several keywords are considered together to determine the best advertisement. In addition to keywords, other factors can be considered. For example, browsing history, favorites, and other indications can be given weight towards a final selection.

At step 240, an advertisement having the best match between keywords and metadata is selected. In one implementation, the top five advertisements are queued up to be served to the user. In one implementation, a highest correlation score is selected as the best match. The most weight can be given to direct matches of characters between a keyword and metadata. In one embodiment, the selected advertisement is identified with a unique identification tag. The method ends at step 295.

FIG. 3 is a flow chart illustrating a method 300 for selecting an online advertisements based on an image analysis of the avatar according to an embodiment.

The method starts at step 305. At step 310, an avatar image is received. The avatar image can be extracted from a web page when initially selected or when modified. In one embodiment, a user profile is polled at predetermined intervals to retrieve the latest avatar image. In alternative embodiment, a video image is received.

At step 320, image recognition is used to identify elements of an avatar. Specific image recognition techniques are implementation-specific. Image recognition can include facial recognition, pattern recognition, and the like. More detailed techniques for image recognition can include classification or clustering (e.g., k-means clustering), transformation to vector space, probability analysis, vector machines, Markov modeling, Kalman filtering, principal component analysis (PCA), and independent component analysis (ICA).

The image recognition is used to identify physical attributes of the avatar and of a background environment. A special database can be provided for matching characteristics such as logos, types of clothing, and the like.

In one embodiment, steps 330, 340 and 350 can be similar to steps, 220, 230 and 240 described above. At step 330, a keyword describing an avatar characteristic is received. Next, at step 340, metadata associated with the advertisements are matched to the keyword associated with an avatar characteristic. Finally, at step 350, a best match is selected by output using a highest correlation score. The method and at step 395.

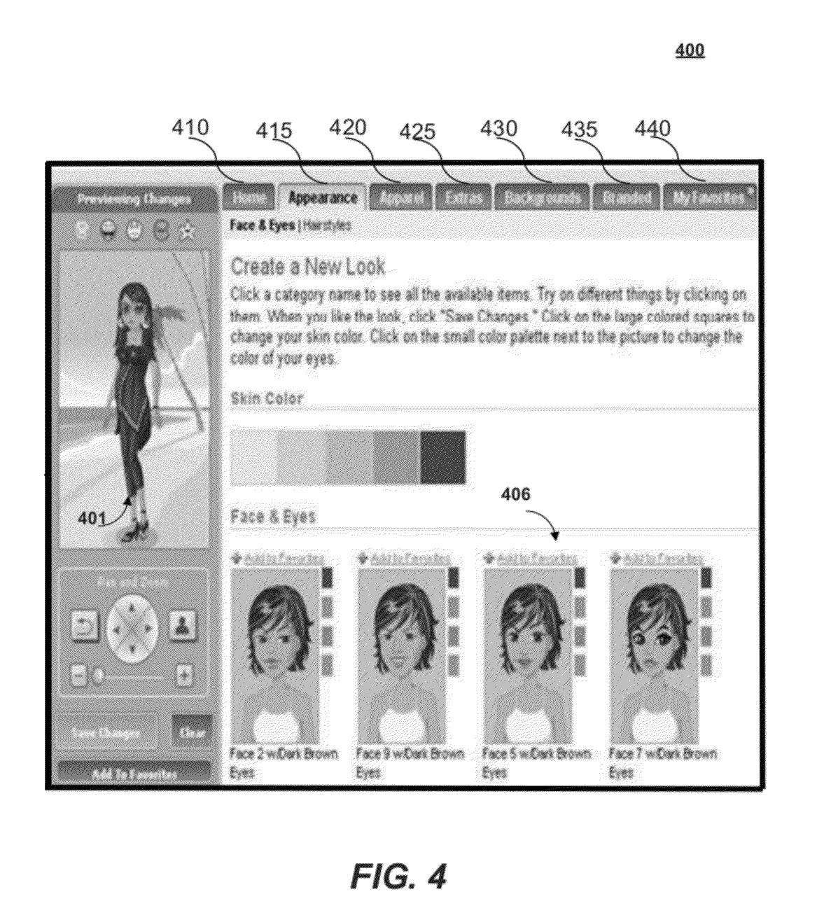

FIG. 4 is a schematic diagram illustrating a graphical user interface (GUI) 400 for an exemplary selection of an avatar characteristic in accordance with one embodiment.

The GUI 400 can be implemented in a web page. Further, the GUI 400 includes options for a user to select desired characteristics associated with the avatars. The options are viewable through tabs for Home 410, Appearance 415, Apparel 420, Extras 425, Backgrounds 430, Branded 35, and Favorites 440. Home 410 can be a profile home page which shows an avatar 401 in context with its use. Examples include mail, news feeds, weather, and other customizable features.

Appearance 415 can relate to physical characteristics of the avatar such as face shape, eye shape, eye color, hair type, hair color, hair length, complexion, height, body proportion, pose, shoe size, and the like. There are several alternatives to choosing an appearance feature. In one example, several snapshots 406 can be displayed, each showing the feature variation. Additionally, a scroll bar, a color palette, a joystick, or other gadget can be used in coordination with a user device such as a mouse or keyboard.

Apparel 420 can be articles of clothing used to dress the avatar 401. Types of apparel can include, shirts, pants, shoes, hats, or any article of clothing. Options can include color, and type of fit. Extras 425 can include accessories such as jewelry, bags, and pets. Backgrounds 430 can set an environment such as a beach or office scene. Branded 435 allows selection of brands. Favorites 440 provide shortcuts to user preferred characteristics. Many other characteristics are possible.

The GUI 400 can display a preview of characteristics. The avatar 401 can be moved to different perspectives within the background by using pan and zoom controls. Once complete, a user saves the changes and continues using an application associated with the avatar 401.

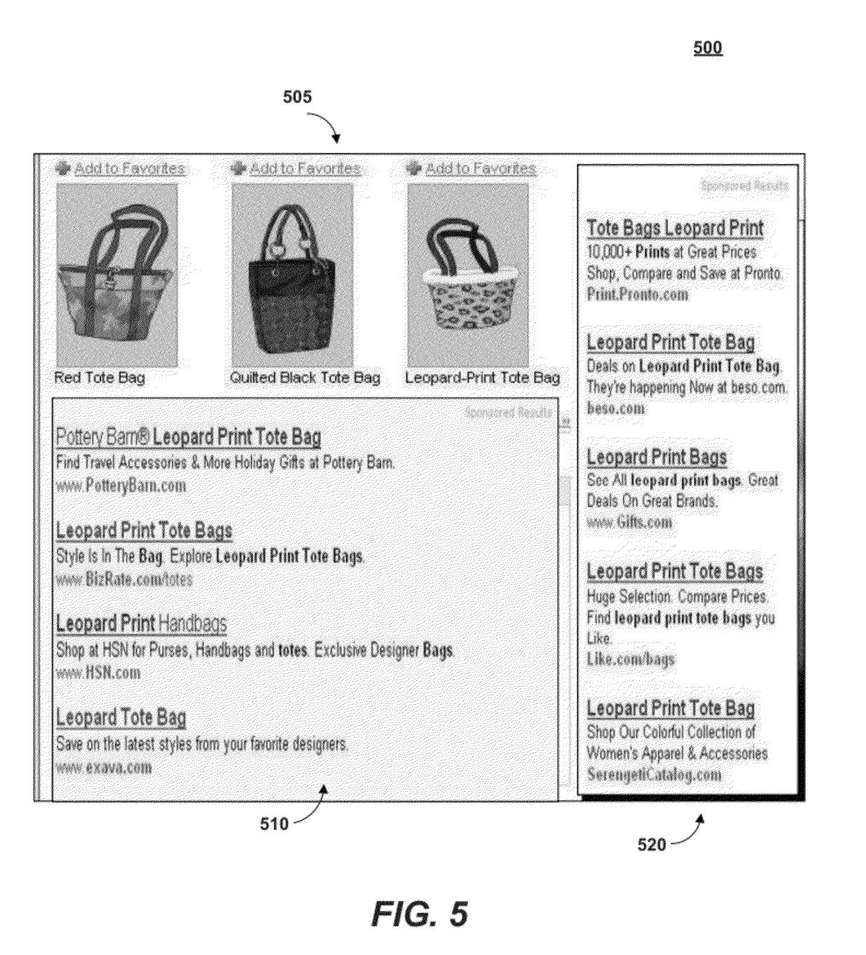

FIG. 5 is an exemplary representation of a GUI 500 with advertisements selected responsive to modifications of avatar characteristics according to one embodiment.

In this example, a user is selecting a type of bag accessory for an avatar. Several snapshots of bags 505 are provided as options, a red tote bag, a quilted black tote bag, and a leopard-print tote bag.

In one panel 510, a list of selected text advertisements are shown. Each of the advertisements are related to the current characteristic being modified. Hyperlinks allow a user to click for additional information. In other words advertisements are selected and displayed in substantially real-time with a corresponding characteristic selection. In another panel 520, additional advertisements are shown.

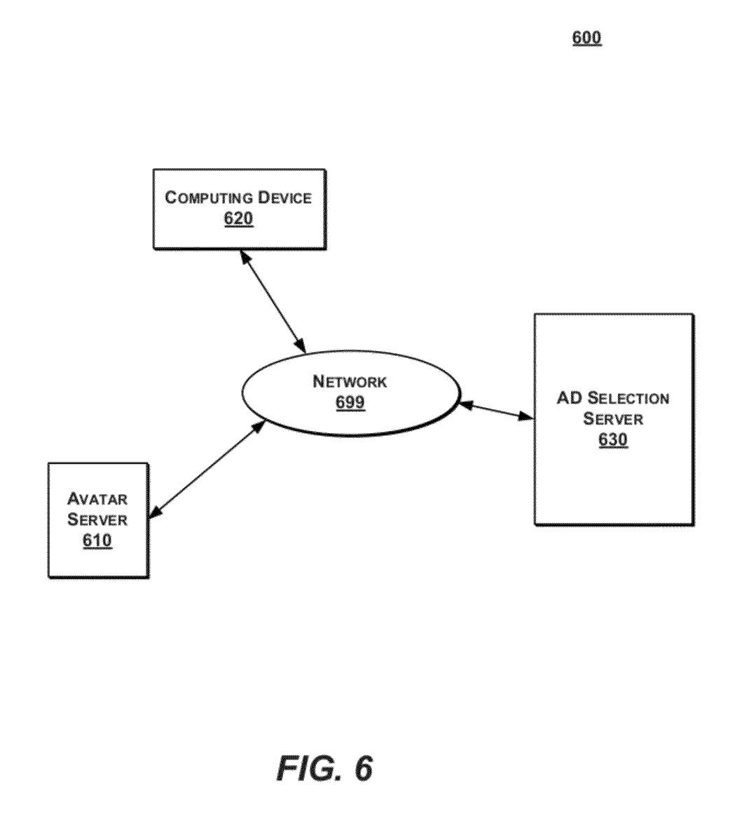

FIG. 6 is a block diagram illustrating a system to provide online advertisements based on an avatar according to one embodiment. The system 600 can implement methods discussed above. The system 600 includes an avatar server 610, a computing device 620, and an ad selection server 630, coupled in communication through a network 699 (e.g., the Internet or a cellular network).

The avatar server 610 can be, for example, a PC (Personal Computer), a laptop, a tweet blade, or any other individual or groups of computing devices. In one embodiment, the avatar server 610 can store avatars (e.g., in an avatar database) along with user profiles. The avatar server 610 can also include an application for avatar selection and customization. In one embodiment, the avatar server 610 is in communication with the ad selection server 630 (e.g., when both devices are owned by the same entity) to send notifications of avatar changes.

The computing device 620 can be, for example, a PC, a stationary computing device, a laptop or notebook computer, a tablet computer, a smart phone or PDA, a smart appliance, a video gaming console, an Internet television, a set-top box, or any other suitable processor-based device that can send tweets. There can be numerous computing devices 620 used by different users. In one embodiment, the computing device 620 allows a user to select and modify avatars. Additional embodiments of the computing device 620 are described in more detail below.

The ad selection server 630 can be one or more of any of the above processor-based devices. In one embodiment, the ad selection server 630 selects one or more advertisements to be displayed to a user responsive to an avatar. Additional embodiments of the ad selection server 630 are described in more detail below.

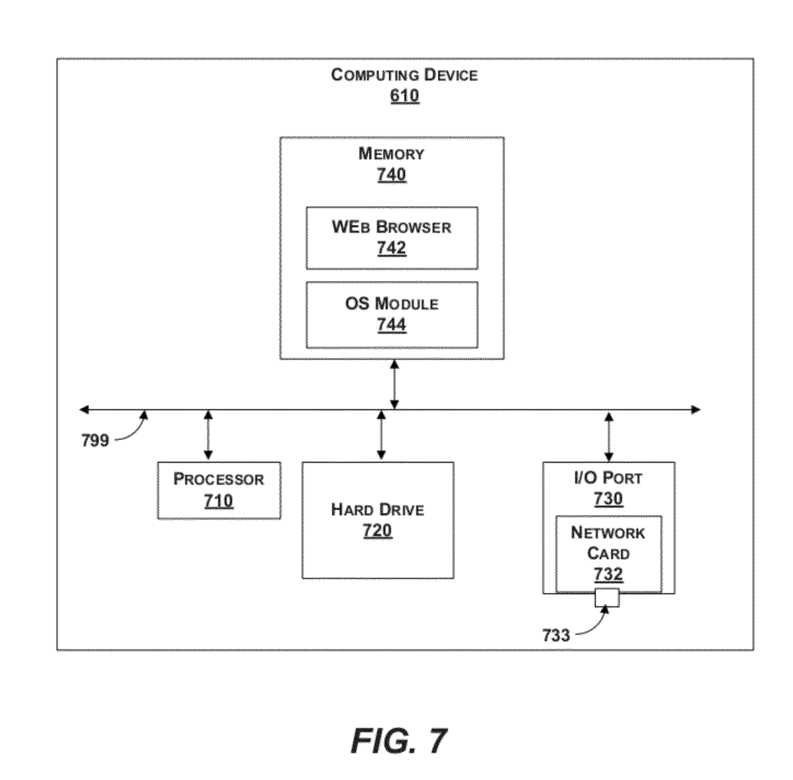

FIG. 7 is a block diagram illustrating an exemplary computing device 610 according to one embodiment. The computing device 610 includes a processor 710, a hard drive 720, an I/O port 730, and a memory 740 coupled by a bus 799. In one embodiment, the computing device 610 is customized for use in an environment associated with the avatar (e.g., video gaming console in which an avatar is used as a character in a game). In other embodiments, the computing device 610 is a general computing device.

The bus 799 can be soldered to one or more motherboards. The processor 710 can be a general purpose processor, an application-specific integrated circuit (ASIC), an FPGA (Field Programmable Gate Array), a RISC (Reduced Instruction Set Controller) processor, an integrated circuit, or the like. There can be a single core, multiple cores, or more than one processor. In one embodiment, the processor 710 is specially suited for the processing demands of avatar selection (e.g., custom micro-code, instruction fetching, pipelining or cache sizes). The processor 710 can be disposed on silicon or any other suitable material. In operation, the processor 710 can receive and execute instructions and data stored in the memory 740 or the hard drive 720. The hard drive 720 can be a platter-based storage device, a flash drive, an external drive, a persistent memory device, or any other type of memory.

The hard drive 720 provides persistent (i.e., long term) storage for instructions and data. The I/O port 720 is an input/output panel including a network card 702. The network card 732 can be, for example, a wired networking card (e.g., a USB card, or an IEEE 802.3 card), a wireless networking card (e.g., an IEEE 802.11 card, or a Bluetooth card), a cellular networking card (e.g., a 3G card). An interface 733 is configured according to networking compatibility. For example, a wired networking card includes a physical port to plug in a cord, and a wireless networking card includes an antennae. The network card 732 provides access to a communication channel on a network. The network card 732 provides communication to GPS satellites operating space to receive location data

The memory 740 can be a RAM (Random Access Memory), a flash memory, a non-persistent memory device, or any other device capable of storing program instructions being executed. The memory 740 further comprises a web browser 742, and an OS (operating system) module 744. The tweet module comprises any type of tweet client or web browser used to send tweets with geotags. The OS module 744 can be one of the Microsoft Windows® family of operating systems (e.g., Windows 95, 98, Me, Windows NT, Windows 2000, Windows XP, Windows XP x64 Edition, Windows Vista, Windows CE, Windows Mobile), Linux, HP-UX, UNIX, Sun OS, Solaris, Mac OS X, Alpha OS, AIX, IRIX32, or IRIX64.

The web browser 742 can be a desktop web browser (e.g., Internet Explorer, Mozilla, or Chrome), a mobile browser, or a web viewer built integrated into an application program. In an embodiment, a user accesses a system on the World Wide Web (WWW) through a network such as the Internet. The web browser 742 is used to download web pages or other content in various formats including HTML, XML, text, PDF, and postscript, and may be used to upload information to other parts of the system. The Web browser may use URLs (Uniform Resource Locators) to identify resources on the web and HTTP (HyperText Transfer Protocol) in transferring files on the web. In one embodiment, the web browser 742 allows a user to select and modify avatars on a web page. The web page can also include advertisement selected as described herein.

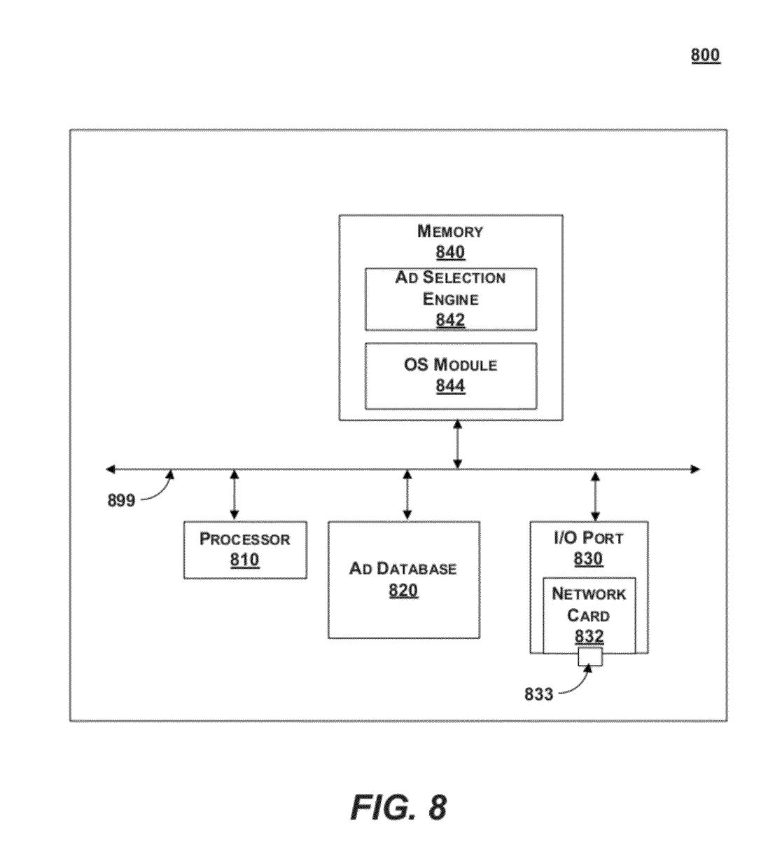

FIG. 8 is a block diagram illustrating an exemplary avatar server 630 according to one embodiment. The avatar server 630 includes a processor 810, an advertisement database 820, an I/O port 830, and a memory 840, coupled by a bus 899. The processor 810, a hard drive with the ad database 820, and the I/O port 830 can be configured as described above with respect to FIG. 7.

The memory 840 comprises an OS module 844, as described above, along with an ad selector engine 842. The ad selector engine 842 can select an advertisement from the ad database 820. Both are described in more detail below

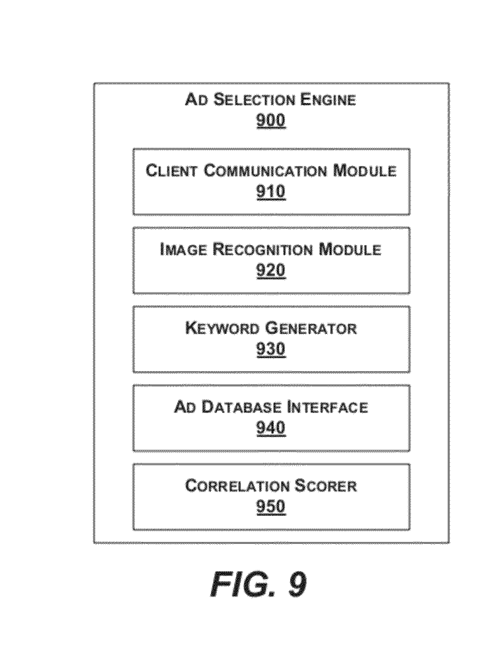

FIG. 9 is a block diagram illustrating an exemplary ad selection engine 900 according to one embodiment. The ad selector engine 900 includes a client communication module 910, an image recognition module 920, a keyword generator 930, ad database interface 940, and a correlation scorer 950. The components can communicate with each other through, for example, APIs (Application Programming Interfaces). In other embodiments, all or parts of the components can be implemented in hardware or benefit from special hardware accelerators.

The client communication module 910 communicates with, for example, the avatar server 610 or the computing device 620 to receive an avatar or indications of changes to an avatar. The image recognition module 920 analyzes an avatar image to determine characteristics of an avatar and background. The keyword generator 930 uses avatar characteristics and changes to identify descriptive keywords. The ad database interface 940 uses the keywords to pull advertisements from the ad database 820. The correlation scorer 950 ranks advertisements with a correlation score and selects one or more of the advertisement. The client communication module 910 transmits the advertisement for display to a user in association with an avatar.

As described herein, computer software products may be written in any of various suitable programming languages, such as C, C++, C#, Pascal, Fortran, Perl, Matlab (from MathWorks), SAS, SPSS, JavaScript, AJAX, and Java. The computer software product may be an independent application with data input and data display modules. Alternatively, the computer software products may be classes that may be instantiated as distributed objects. The computer software products may also be component software such as Java Beans (from Sun Microsystems) or Enterprise Java Beans (EJB from Sun Microsystems). Many of the functionalities described herein can be implemented in computer software, computer hardware, or a combination.

Furthermore, the computer that is running the previously mentioned computer software may be connected to a network and may interface to other computers using this network. The network may be an intranet, internet, or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, and 802.11n, just to name a few examples). For example, signals from a computer may be transferred, at least in part, wirelessly to components or other computers.

It is to be understood that although various components are illustrated herein as separate entities, each illustrated component represents a collection of functionalities which can be implemented as software, hardware, firmware or any combination of these. Where a component is implemented as software, it can be implemented as a standalone program, but can also be implemented in other ways, for example as part of a larger program, as a plurality of separate programs, as a kernel loadable module, as one or more device drivers or as one or more statically or dynamically linked libraries.

As will be understood by those familiar with the art, the invention may be embodied in other specific forms without departing from the spirit or essential characteristics thereof. Likewise, the particular naming and division of the portions, modules, agents, managers, components, functions, procedures, actions, layers, features, attributes, methodologies and other aspects are not mandatory or significant, and the mechanisms that implement the invention or its features may have different names, divisions and/or formats.

Furthermore, as will be apparent to one of ordinary skill in the relevant art, the portions, modules, agents, managers, components, functions, procedures, actions, layers, features, attributes, methodologies and other aspects of the invention can be implemented as software, hardware, firmware or any combination of the three. Of course, wherever a component of the present invention is implemented as software, the component can be implemented as a script, as a standalone program, as part of a larger program, as a plurality of separate scripts and/or programs, as a statically or dynamically linked library, as a kernel loadable module, as a device driver, and/or in every and any other way known now or in the future to those of skill in the art of computer programming. Additionally, the present invention is in no way limited to implementation in any specific programming language, or for any specific operating system or environment.

Furthermore, it will be readily apparent to those of ordinary skill in the relevant art that where the present invention is implemented in whole or in part in software, the software components thereof can be stored on computer readable media as computer program products. Any form of computer readable medium can be used in this context, such as magnetic or optical storage media. Additionally, software portions of the present invention can be instantiated (for example as object code or executable images) within the memory of any programmable computing device.

Accordingly, the disclosure of the present invention is intended to be illustrative, but not limiting, of the scope of the invention, which is set forth in the following claims.

What is claimed is:

1. A method for providing digital advertisements based on avatar changes, comprising:
displaying an avatar;
receiving a change to a characteristic associated with the avatar;
selecting an advertisement based on the characteristic change in relation to metadata associated with the advertisement; and
displaying the selected advertisement.

2. The method of claim 1, wherein the avatar is associated with a user of a social network, with a profile of a user, or with a player of a video game.

3. The method of claim 1, wherein the characteristics change comprises a change to a visual appearance of the avatar.

4. The method of claim 3, wherein selecting the advertisement comprises selecting the advertisement by matching a description of the characteristic change to a description of the advertisement.

5. The method of claim 1, wherein receiving the change comprises receiving a plurality of changes to a corresponding plurality of characteristics associated with the avatar.

6. A computer-implemented method for providing digital advertisements based on avatar changes, comprising:
receiving an avatar;
performing an image analysis on the avatar to determine characteristics associated with the avatar;
selecting an advertisement based on at least one characteristic in relation to metadata associated with the advertisement; and
displaying the selected advertisement.

7. The method of claim 6, wherein performing the image analysis comprises performing the image analysis on the avatar to determine appearance characteristics associated with the avatar.

8. The method of claim 6, wherein selecting the advertisement comprises selecting the advertisement by matching a description of the characteristic change to a description of the advertisement.

9. A computer program product stored on a non-transitory computer-readable medium that when executed by a processor, performs a method for providing online advertisements based on avatar changes, comprising:
displaying an avatar;
receiving a change to a characteristic associated with the avatar;
selecting an advertisement based on the characteristic change in relation to metadata associated with the advertisement; and
displaying the selected advertisement.

10. The computer program product of claim 9, wherein the avatar is associated with a user of a social network, with a profile of a user, or with a player of a video game.

11. The computer program product of claim 9, wherein the characteristics change comprises a change to a visual appearance of the avatar.

12. The computer program product of claim 11, wherein selecting the advertisement comprises selecting the advertisement by matching a description of the characteristic change to a description of the advertisement.

13. The computer program product of claim 9, wherein receiving the change comprises receiving a plurality of changes to a corresponding plurality of characteristics associated with the avatar.

14. A system to provide digital advertisements based on avatar changes, comprising:
an interface to receive a change to a characteristic associated with an avatar from a client that manages the avatar;
an advertisement selector engine, communicatively coupled to the interface, the advertisement selection engine to select an advertisement based on a change to a characteristic in relation to metadata associated with the advertisement,
wherein the interface sends the selected advertisement to the client for display.

15. The system of claim 14, wherein the avatar is associated with a user of a social network, with a profile of a user, or with a player of a video game.

16. The system of claim 14, wherein the characteristics change comprises a change to a visual appearance of the avatar.

17. The system of claim 16, wherein the advertisement selection engine selects the advertisement by matching a description of the characteristic change to a description of the advertisement.

18. The system of claim 14, wherein the interface receives a plurality of changes to a corresponding plurality of characteristics associated with the avatar.

19. The system of claim 14, wherein the interface displays the advertisement as the characteristic change is being selected.

20. The system of claim 15, further comprising:
an image analyzer, communicatively coupled to the advertisement selector engine, to perform an image analysis on the avatar to determine characteristics of the avatar.
